(19) United States
(12) Patent Application Publication
(10) Pub. No.: US 2009/0226667 A1
(43) Pub. Date: Sep. 10, 2009

(54) SILICON SUBSTRATE FOR MAGNETIC RECORDING AND METHOD FOR MANUFACTURING THE SAME

(75) Inventor: Ken Ohashi, Tokyo (JP)

Correspondence Address: MYERS BIGEL SIBLEY & SAJOVEC, PO BOX 37428, RALEIGH, NC, 27627, US

(73) Assignee: Shin-Etsu Chemical Co., Ltd.

(21) Appl. No.: 12/399,136

(22) Filed: Mar. 6, 2009

(30) Foreign Application Priority Data
Mar. 7, 2008 (JP) 2008-057785

(51) Int. Cl. B32B 3/00; B32B 5/00; B05D 5/12

(52) U.S. Cl. 428/141; 428/336; 427/127

(57) ABSTRACT

A Si substrate for a magnetic recording medium having excellent surface flatness without making a processing process and deposition process of a magnetic recording layer complex, as well as a thermal conductivity that is unchanged from a bulk substrate of a single crystal and a polycrystal is provided. A metal film is deposited (S7) on a polycrystalline silicon substrate after rough polishing (S6) and silicidated or silicon-alloyed (S8). Thereafter, the film is subjected to precision polishing (S9) such as CMP polishing to increase the flatness of the substrate. Accordingly, the Si substrate for a magnetic recording medium can obtain a flat and smooth surface without being influenced by a difference between crystal orientations of the polycrystalline grains and the presence of crystal grain boundary, and can obtain heat resistance and a thermal conductivity approximately equivalent to a bulk Si substrate.

### CROSS-RELATED APPLICATIONS

This application claims priority from Japanese Patent Application No. 2008-057785; filed Mar. 7, 2008, the disclosure of which is incorporated herein by reference in its entirety.

### BACKGROUND OF THE INVENTION

1. Field of the Invention

The present invention relates to a polycrystalline silicon substrate used for magnetic recording, and a method for manufacturing the same.

2. Description of the Related Art

In the technical field of magnetic recording, a hard disk device has been essential as a primary external recording device suitable for electronic devices such as personal computers. A hard disk is incorporated into the hard disk device as a magnetic recording medium, and conventional hard disks have adopted a system known as the “in-plane magnetic recording system (horizontal magnetic recording system)” in which magnetic information is written horizontally on the disk surface.

FIG. 3(A) is a schematic sectional view for illustrating the general layered structure in the hard disk of the horizontal magnetic recording system. On a non-magnetic substrate 101, a Cr-based foundation layer 102 formed by sputtering, a magnetic recording layer 103, and a carbon layer 104 as a protective film are sequentially deposited. On the surface of the carbon layer 104, a liquid lubricating layer 105 formed by applying a liquid lubricant (for example, refer to JP 5-143972 A). The magnetic recording layer 103 is composed of a uniaxial magnetic anisotropic Co alloy, such as CoCr, CoCrTa, and CoCrPt. The crystal grains of the Co alloy are magnetized in horizontal to the disk surface so as to record data. The arrows in the magnetic recording layer 103 in FIG. 3(A) show the directions of magnetization.

In such a horizontal magnetic recording system, however, if the size of each recording bit is reduced in order to increase the recording density, both N-poles and S-poles in adjacent recording bits repel one another so that the boundary region of the adjacent recording bits can be magnetically obscured. Therefore, in order to increase the recording density, it is necessary to reduce the thickness of the magnetic recording layer and the size of the crystal grains. It has been noted that when the crystal grains are minimized (volume reduction) and the recording bits are minimized, a “heat fluctuation” phenomenon may arise in which the magnetizing direction of the crystal grains are disturbed by thermal energy and data is erased, and it has been recognized that there is limitation in high recording density. In other words, if the KuV/k_{B}T ratio (where Ku is the crystal magnetic anisotropic energy, V is the volume of a recording bit, k_{B} is the Boltzmann constant, and T is an absolute temperature (K)) is small, the effect of heat fluctuation becomes serious.

In view of such a problem, the “vertical magnetic recording system” has been developed. In this recording system, since the magnetic recording layer is magnetized vertically to the surface of the disk, a N-pole and a S-pole are alternately bundled and bit-disposed, and the N-pole and the S-pole in a magnetic domain are adjacent one another to enhance magnetization mutually, resulting in the high stabilization of magnetized state (magnetic recording). Specifically, when the magnetizing direction is vertically recorded, the demagnetizing field of the recording bits is reduced, the thickness of the recording layer is not necessarily small compared with the thickness in the horizontal magnetic recording system. Therefore, if the recording layer is thickened in the vertical direction, the KuV/k_{B}T ratio is increased, and the effect of “heat fluctuation” can be reduced.

As described above, the vertical magnetic recording system can achieve the reduced demagnetizing field and the sufficient KuV value so as to reduce the instability of magnetization due to “heat fluctuation”, which overcomes the limit of the recording density. The vertical magnetic recording system has been practically used as a method for realizing the ultra-high density recording.

FIG. 3(B) is a schematic sectional view for illustrating a basic layered structure of a hard disk as a “vertical two-layer magnetic recording medium” having a recording layer for vertical magnetic recording on a soft magnetic lining layer. On a non-magnetic substrate 111, a soft magnetic lining layer 112, a magnetic recording layer 113, a protective layer 114, and a lubricating layer 115 are sequentially deposited. Here, the soft magnetic lining layer 112 is typically composed of permalloy, amorphous CoZrTa, or the like. As the magnetic recording layer 113, a CoCrPt-based alloy, a CoPt-based alloy, or a multilayer film formed by alternately laminating several layers of PtCo layers and ultra-thin Pd and Co films is used. The arrows in the magnetic recording layer 113 in FIG. 3(B) show the directions of magnetization.

As shown in FIG. 3(B), in the hard disk of the vertical magnetic recording system, a soft magnetic lining layer 112 is provided as the foundation layer of the magnetic recording layer 113. The magnetic characteristics thereof is “soft magnetic”, and the thickness of the layer is about 100 to 200 nm. The soft magnetic lining layer 112 is provided to obtain the effect of expanding writing magnetic field and to reduce the demagnetization field of the magnetic recording film, and functions as the path of flux from the magnetic recording layer 113 as well as the path of flux for writing from the recording head. Specifically, the soft magnetic lining layer 112 plays a roll equivalent to the iron yoke in the permanent magnet magnetic circuit. Therefore, for avoiding magnetic saturation in writing, the thickness of the soft magnetic lining layer 112 must be determined so as to be thicker than the thickness of the magnetic recording layer 113.

The horizontal magnetic recording system as shown in FIG. 3(A) is progressively replaced with the vertical magnetic recording system across a recording density of 100 Gbit to 150 Gbit per square inch as the boundary due to the recording limit caused by the heat fluctuation and the like, and the vertical magnetic recording system has been established as the mainstream system. Although the recording limit in the vertical magnetic recording system is unclear at present, it is presumed to be 500 Gbit per square inch or higher, and it is recognized that a high recording density of about 1000 Gbit per square inch will be able to be achieved. If such a high recording density is achieved, the recording capacity of 600 Gbyte to 700 Gbyte per 2.5-inch HD platter can be obtained.

Generally, for the use of the substrate for the magnetic recording medium applied to an HDD, an Al alloy substrate can be used as a substrate of a diameter of 3.5 inches, and a glass substrate is used as a substrate of a diameter of 2.5 inches. In particular, in a mobile use such as a notebook personal computer, a HDD is frequently subject to impact from the outside. It is likely that the recording medium or the substrate may be scratched or data may be destroyed due to the “hitting” of the magnetic head in a 2.5-inch HDD. Accordingly, a glass substrate having a high hardness has been used as a substrate for the magnetic recording medium.

Although the recording densities can be continuously improved by the current vertical magnetic recording using a continuous recording medium, a novel technique must be introduced on the basis of vertical magnetic recording in order to achieve a high recording density of about 1000 Gbit per square inch or higher. It is considered difficult to meet all the requirements of signal-to-noise ratio of media, thermal stability, and writability by means of vertical magnetic recording using a current continuous recording medium.

As a novel technique, a system has been considered in which, for example, a soft magnetic lining layer 122 is formed on a glass substrate 121, ribs 123 of the magnetic layer are concentrically formed thereon with different diameters, and grooves between the ribs are filled with non-magnetic material 124 by the micro-fabrication of the media (discrete track media or bit-patterned media shown in FIG. 4), as well as a heat-assisted magnetic recording system (FIG. 5(A)).

For example, in the bit-patterned media by the micro-fabrication of media, the microfabrication is required so as to have a line width finer than that of the current LSI micro-fabrication (dot processing of about 25 nm pitch and 20 nm diameter for the recording density of 1000 Gbit per square inch). Microfabrication should be carried out on the entire surface of a substrate to keep substantially all the region sound and within a certain dimensional error range and to maintain sound magnetic characteristics. Since technical difficulty is high, it is not easy to achieve a good balance between the costs and mass-production.

On the other hand, in heat-assisted magnetic recording shown in FIG. 5, a light from a laser 131 is collected (for example, 20 nm diameter or smaller), the temperature of the light focused portion of the magnetic layer 132 is elevated in a short time, and immediately, signals are written in the temperature elevating section 133 with reduced coercive force using the writing coils 134. Here, the heating spot must be decreased to the diffraction limit of the light for improving the recording density.

Therefore, it is essential that the magnetic head 139 is integrated with a near-field optical element (not shown), light is focused into the small region using near-field light while floating the bed at a low rate, and the generated heat and magnetic field are synchronized for writing. It is difficult, however, to develop a composite head of the magnetic head 139 and the near-field optical element is extremely high. In FIG. 5(A), two shields 136 are disposed adjacent to the magnetic head 139 with a certain spacing therebetween, and a GMR element 138 which is connected to a wiring 137 is disposed as a sensing element in the spacing.

While FePt or SmCo5 having high crystalline magnetic anisotropy is considered as one of candidate materials for the magnetic recording layer, FePt and SmCo require high temperature in the film-forming process due to the significantly different film-forming condition from a conventional CoCrPt-based material.

Even if the limit of magnetic recording density can be overcome by any method, there is an extremely large barrier between technical difficulty and mass production.

Although FePt and the like are studied as a next-generation material for recording layers in heat-assisted magnetic recording, heat treatment at a high temperature, such as about 600° C. is required for elevating coercive force. Therefore, the lowering of the temperature for heat treatment is studied; however, heat treatment at 400° C. or higher is required. These temperatures are higher than temperatures endurable by the use of presently used amorphous glass substrates, and the substrates are softened. An Al substrate having amorphous NiP film formed by plating also cannot resist the treatment at such a high temperature. NiP is crystallized at such a high temperature, and once flattened surface characteristics are significantly lowered. Therefore, a substrate suitable for a heat-assisted magnetic recording film is required.

While a sapphire-glass substrate, a SiC substrate, a carbon substrate, and the like can replace the glass substrates and Al substrates, none of these are satisfactory at present in terms of strength, workability, costs, surface flatness, film formability and thermal conductivity.

### SUMMARY OF THE INVENTION

Taking these situations into account, the present inventors have already proposed the use of a single crystalline silicon (Si) substrate as a substrate for an HDD recording film (for example, refer to JP 2005-108407 A).

The single crystalline Si substrate has been widely used as a substrate for manufacturing an LSI. Since the single crystalline Si substrate excels in surface flatness, environmental stability, and reliability, as well as high rigidity compared with the rigidity of glass, the single crystalline Si substrate is suitable for an HDD substrate. In addition, the single crystalline Si substrate shows semiconductive behavior unlike an insulating glass substrate, often contains p-type or n-type dopant, and has conductivity to a certain degree. Therefore, “charge-up” is relatively reduced in the sputtering process, enabling the direct sputtering or the bias sputtering of a metal film. Furthermore, since the single crystalline Si substrate has favorable heat conductivity and high heat resistance, the substrate can easily be heated to a high temperature, and good compatibility with the sputtering film forming is extremely high. Moreover, since the crystal purity of the Si substrate is extremely high, there are advantages that the surface of the substrate after processing is stable, and the temporal change can be ignored.

However, the only weak point is the high costs of the 48 mm-diameter or larger single crystalline Si wafer.

The present inventors have also proposed the use of a polycrystalline silicon (Si) substrate as a substrate of a HDD recording film. Polycrystalline Si has various selections of material in terms of purity, and excels in the cost performance of the substrate.

The use of a polycrystalline substrate as it is, and the use of a polycrystalline substrate after forming an oxide film on the surface and planarizing and flattening the film have been developed. Although the former has a simple configuration wherein the single crystalline Si is simply replaced by the polycrystalline Si, the polycrystalline Si substrate is relatively inferior to the single crystalline Si substrate in the strength of the substrate and the defect of polished surface. The strength of the latter is higher than the strength of the single crystalline Si substrate, and since the silicon oxide film is amorphous, excellent surface characteristics can be obtained after polishing. However, since the oxide film having low thermal conductivity is present on the surface, the heat conductivity from the surface of the substrate in the vertical direction is affected. Particularly in the heat-assisted magnetic recording, the design for releasing heat applied in writing may be affected.

The present invention has been made in view of the above problems, and an object of the present invention is to provide a surface-coated polycrystalline Si substrate for a magnetic recording medium and a recording medium, which are aimed at substrates for magnetic recording having a diameter of 48 mm or more, the polycrystalline Si substrate having excellent surface flatness and smoothness as well as high cost-effectiveness without impairing most thermal conductive properties of the polycrystalline Si substrate.

In order to solve the above problems, a silicon substrate for a magnetic recording medium of the present invention may comprise a polycrystalline silicon substrate having a purity of 99.99% or higher, and a silicide film or a silicon alloy film on a major surface of the polycrystalline silicon substrate, in which a root mean square value of roughness thereof is 0.5 nm or less.

The polycrystalline silicon substrate of the present invention has a diameter of e.g. 48 mm or more, and the silicide film or the silicon alloy film has a thickness of 50 nm or more but not more than 3 μm. A manufacturing process of the silicide film comprises: firstly, a metal film is deposited on a polycrystalline silicon substrate that has been subjected to rough polishing; subsequently, the temperature of the substrate is increased; and the metal film and the silicon substrate is reacted to silicidate or silicon-alloy the entire metal film. The resulting film has an excellent high temperature resistant, and no change in the resulting film occurs even when the film is heated to 500° C. or higher. Polishing the surface of the silicide film or the silicon alloy film provides a smooth surface thereof to allow it to be used as a HD substrate.

Thermal conductivities of the polycrystalline Si substrate and the upper silicide film or silicon alloy film of a substrate of the present invention is only twice or several times as high as that of Si of a substrate (30 to 80 W/m·K). Therefore, a magnetic recording medium such as a heat-assisted magnetic recording medium with excellent thermal conductivity and heat resistance may be obtained by providing a magnetic recording layer on the silicon substrate. The substrate of the present invention, of course, may be used as a recording substrate for a conventional perpendicular magnetic recording and bit patterned media.

A method for manufacturing a silicon substrate for a magnetic recording medium of the present invention comprises: precision grinding and polishing a major surface of a polycrystalline silicon substrate having a purity of 99.99% or higher (S6); forming a metal film on the major surface (S7); silicidating or alloying the substrate with the metal film with the temperature of the substrate increased (S8); and final polishing for smoothing the silicide film (S9). The above forming a metal film (S7) is carried out by forming a film on the major surface on the polycrystalline silicon substrate using CVD or PVD. The performing heat treatment for the silicidation (S8) is carried out, under vacuum or an inert gas atmosphere, by resistance heating, infrared heating, induction heating or the like. The above polishing the film (S9) is carried out by being subjected to CMP treatment such that a roughness of the substrate has a root mean square value of 0.5 nm or less.

A magnetic recording medium is formed by appropriately depositing a recording film on the polished substrate.

A polycrystalline Si substrate for a magnetic recording medium, which have excellent surface flatness and smoothness as well as high cost-effectiveness, and a recording medium can be provided without impairing a good thermal conductive property of a polycrystalline Si substrate by polishing the silicide film or the alloy film.

### BRIEF DESCRIPTION OF THE DRAWINGS

FIG. 1 is a flowchart showing a process of the present invention;

FIG. 2 is a diagram showing the result of Example 3 of the present invention, which is the result of roughness of a substrate which is subjected to polishing having a Cu silicide film deposited on a polycrystalline Si substrate, the result being obtained by an AFM measurement;

FIG. 3(A) is a schematic cross-sectional view for explaining a typical stacked structure for a hard disk of longitudinal magnetic recording system, and FIG. 3(B) is a schematic cross-sectional view for explaining a basic layered structure for a hard disk as a “double-layered perpendicular magnetic recording medium” with a recording layer for perpendicular magnetic recording provided on a soft magnetic backing layer;

FIG. 4(A) is a schematic diagram showing one aspect of a discrete track magnetic recording medium of a next-generation recording system covered by the present invention; and

FIG. 5(A) is a schematic diagram of a device configuration in a heat-assisted magnetic recording system covered by the present invention, and FIG. 5(B) is a graph showing change in coercitivity in an elevated temperature and a heat radiation processes.

### DETAILED DESCRIPTION OF THE PREFERRED EMBODIMENTS

The present invention now will be described more fully hereinafter in which embodiments of the invention are provided with reference to the accompanying drawings. This invention may, however, be embodied in many different forms and should not be construed as limited to the embodiments set forth herein; rather, these embodiments are provided so that this disclosure will be thorough and complete, and will fully convey the scope of the invention to those skilled in the art.

The terminology used in the description of the invention herein is for the purpose of describing particular embodiments only and is not intended to be limiting of the invention. As used in the description of the invention and the appended claims, the singular forms “a”, “an” and “the” are intended to include the plural forms as well, unless the context clearly indicates otherwise.

Unless otherwise defined, all technical and scientific terms used herein have the same meaning as commonly understood by one of ordinary skill in the art to which this invention belongs.

Hereinafter, preferred embodiments of the present invention will be described. However, it is to be understood that the present invention is not limited thereto.

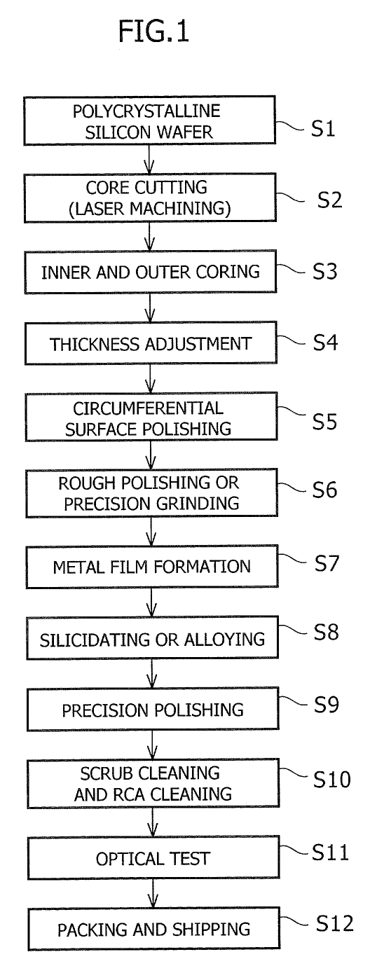

FIG. 1 is a flowchart for explaining an exemplary manufacturing process of a Si substrate for a magnetic recording medium of the present invention. Firstly, a polycrystalline Si wafer is prepared for obtaining a Si substrate for HD by coring (S1). The polycrystalline Si wafer has preferably a high purity, but need not be one having so-called “semiconductor grade” (generally, its purity is “11 nines” (99.999999999%) or more), and may be one having substantially “solar grade”. Though the polycrystalline Si wafer having the solar grade generally has a purity of about “8 nines” (99.999999%), it is acceptable for the polycrystalline Si wafer of the present invention to have a purity down to “4 nines” (99.99%). In an application of a substrate for magnetic recording of the present invention, it is not necessary to control the amount of dopant such as the amount of boron (B) and phosphorus (P) since the polycrystalline Si is basically used as a structural material, unlike solar cell applications. Desirably, an insoluble impurity (SiNx, SiC or the like) contained in a raw material (a polycrystalline Si wafer) is small in amount, but a practical issue does not occur since a top portion thereof is covered with a silicide film or an alloy film.

The polycrystalline Si wafer may also be a rectangular or disk-like shape (S1). The Polycrystalline Si wafers for solar cells has generally a rectangular shape, and therefore, in an exemplary process of Example, the polycrystalline Si wafer having such shape is shown as an example. Desirably, the average grain size in polycrystalline grains is 1 mm or more but not more than 15 mm from the standpoint of strength and shock resistance of the polycrystalline Si wafer itself. However, it is also acceptable for smaller grains to be mixed therein since, of the present invention, a top portion thereof is covered with the silicide film to improve the strength thereof.

Coring processing (S2) comprises various methods such as cup cutting with a diamond grindstone, ultrasonic cutting, blast processing, and water-jet treatment, of which laser coring with a solid-state laser is desirable in terms of the ensuring of a processing rate, reduction of the amount of a cutting margin, easy change of bore, easy of jig making and post-processing, and the like. This is because the solid-state laser has a high power density and can converge a beam and therefore provides a relatively clear processed surface with less generation of fusing residue (dross). Laser light sources for use in such a case may include Nd-YAG laser and Yb-YAG laser.

A Si substrate obtained by the coring is subjected to centration and inner and outer coring (S3), subjected to grinding or lapping for adjusting thickness (S4), and thereafter subjected to circumferential surface polishing (S5) so as to prevent occurrence of chipping or the like in the subsequent polishing.

The Si substrate thus obtained is subjected to rough polishing or precision grinding (S6) in order to substantially flatten the surface thereof. In the present invention, the rough polishing for this surface flattening is performed by CMP processing using a neutral or alkaline slurry. Alternatively the precision grinding is performed using particulate diamond fixed abrasive grains (e.g. #4000 or finer) on a ductile region. The reason why polishing is performed on the ductile region is to reduce the layer deteriorated by processing.

Since the Si substrate, which is used in the present invention, is polycrystalline, respective crystal grains have different crystal orientations. If “rough polishing” is performed using ordinary CMP, steps are formed for respective crystal grains due to different polishing speeds in respective crystal grains, and favorable surface flatness cannot be achieved. Therefore, CMP having higher ratio of mechanical polishing is performed to suppress formation of inter-grain steps as much as possible using slurry of a neutral to alkaline range (pH 7 to 10). If the pH of the slurry exceeds 10, the ratio of chemical polishing increases, and the inter-grain steps having different crystal orientations become excessively large. If the pH is at 7 or lower, mechanical polishing becomes the main part of polishing, and polishing speed becomes excessively low. In the rough polishing slurry, for example, ceria or colloidal silica can be used, and the average particle diameter may be 30 nm to 100 nm. Since the polishing speed is important in the rough polishing, the polishing pressure can be set to 5 to 50 kg/cm², which is a little higher than the polishing pressure in the following final polishing process (S8), and the polishing time can be set to 5 to 60 minutes. Since the rough polishing is a process for substantially removing the thickness irregularity and surface steps of the polycrystalline silicon substrate, the flatness of the surface of the Si substrate may be 1 nm or smaller and fine scratches may be present. Precision grinding may also be performed. Although a flat surface cannot be obtained by precision grinding as by polishing, the grinding speed is further high since fixed grind grains are used, and flatness and waviness are favorable, if the height of ground groove can be about 20 nm to 50 nm, the flatness can be achieved by subsequent final polishing (S8).

Subsequently, a metal film is formed on the surface of Si substrate after the rough polishing (S7). The metal film to be used may be one that reacts the Si substrate to form a silicide or an alloy by heating, which comprises e.g. transition metals such as Cu, Ni, Co, Cr, Mo, W, Ti, V, Zr, Nb, and Ta. The metal film may comprise one or more materials among these metals. Al, Au and the like may react with Si at a relatively low temperature to form an Al—Si (Au—Si) alloy layer, though they do not react with Si to form a silicide.

In addition, there are also noble-metal-based silicides such as Pt, Pd, Au, Ru, Rh, Re, Os, and Ir, but these metals have practical drawbacks due to the high cost of their sputtering targets. The metal film may be deposited by PVD such as a sputtering method, but some metal species may also be deposited by a CVD method. The PVD method is very common techniques in thin film fabrication, and has little problem of process safety aspect.

PVD methods include the sputtering method, the ion plating method, and vapor deposition method (including laser deposition method), the magnetron sputtering method and the ion plating method are suitable because of the relatively high film forming speed.

The present inventor can also obtain a smooth substrate with excellent thermal conductivity by depositing a Si film on the polycrystalline substrate and polishing the Si film. The substrate can be formed of the same Si as the film, have approximately the same good thermal conductivity, which are promising and good substrate. A plasma CVD method, which allows its film quality and deposition rate to be compatible, is a promising method for deposition because it is necessary to deposit a good Si thick film (e.g. 500 nm or thicker). The method has a major problem that it is necessary to greatly pay attention to the process safety aspect since monosilane (flammable) is generally used as a working gas. A metal PVD method of the present invention is remarkably superior to the above methods in terms of the process safety aspect.

In the present invention, the metal film formation (S7) is performed mainly by the PVD method such as the sputtering. Subsequently, the substrate is heated under vacuum or an inert gas such as Ar at 1 to 760 Torr, and thus the Si substrate is reacted with the metal film to silicidate or alloy the metal film (S8). While a reaction temperature and reaction time may vary depending on metal species, heat treatment may be performed substantially in the temperature range of 400° C. to 900° C. for about five minutes to about one hour. Heating includes various methods such as resistance heating, infrared heating, and induction heating, and any method may be employed.

The silicide and the silicon alloy layer have excellent strength and heat resistance, as well as have basically good electroconductivity and thermal conductivity. The silicide and a silicon alloy layer can increase the strength of the polycrystalline Si substrate and can improve reliability by covering the film without impairing heat resistance and thermal conductivity required for substrates in a heat-assisted magnetic recording or the like.

In the present invention, after silicidating or alloying, final polishing for smoothing is performed by polishing the surface thereof (S9). Therefore, the metal film needs to have a certain degree of thickness, and preferably has a film thickness of, e.g. 500 nm or thicker when deposited. The thicker the thickness of the silicide film or the alloy film are, the more a processing margin in the polishing increases and the strength thereof also increases, which are preferable. However, such a deposition is too time-consuming and too expensive, and therefore the thickness of a film to be formed may be 4 μm or less.

With the silicide film or the silicon alloy film provided on the substrate surface, its grain boundary that causes to brittleness of substrates is covered with coating to increase the strength of a thin sheet. Moreover, due to crystallite of the film, regardless of grain crystal orientations of the original polycrystalline substrate, processing makes ensuring of surface smoothness easy.

After silicidating or alloying of the metal film, the polycrystalline Si substrate with the thin film is subjected to finishing CMP polishing (S9). Because surface characteristics of the thin film surface has been considerably improved through the rough polishing (S6), a good smooth surface of Ra of 0.5 nm or less can be finally obtained in a relatively short period of time through the finishing CMP polishing.

The thickness of the silicide or alloy film after polishing may be 50 nm to 3 μm. If the thickness is 50 nm or less, a base substrate has a risk of exposing its own surface due to in-plane distribution of the film thickness of the silicide. On the other hand, if the thickness is 3 μm or more, the metal film formation requires a long deposition time and will have a tendency to increase surface roughing due to the effect of residual stress, which are undesirable. The film thickness thereof has more preferably a lower limit of 100 nm and more preferably an upper limit of 1000 nm.

CMP polishing slurry for use in the final polishing process (S9) of the silicide film or silicon alloy film may be common one. For example, slurry of colloidal silica having an average grain diameter of 20 to 80 nm is used with its pH value adjusted into alkaline region of pH 7 to pH 10. The pH adjustment is performed by adding hydrochloric acid, sulfuric acid, hydrofluoric acid or the like. The CMP polishing is performed for about 5 minutes to about 1 hour to attain a desired surface smoothness by using slurry with colloidal silica dispersed, the colloidal silica having a concentration of about 5% to about 30%. Preferably, the final polishing (S9) is performed at the polishing pressure of 1 to 10 kg/cm² which is lower than that of the rough polishing because it is necessary to obtain a good surface having no flaw.

A final polishing including two or more stages, of course, may be also performed in order to obtain a better surface in the final polishing process (S9).

Following the polishing process (S9), scrub cleaning and RCA cleaning (S10) are performed to clean the substrate surface. Subsequently, the substrate surface is optically inspected (S11), and then packed and shipped (S12).

In the polycrystalline Si substrate obtained in this way, both root mean square values of waviness and microwaviness thereof is 0.5 nm or less, so that the polycrystalline Si substrate can obtain adequate surface characteristics as a substrate for hard disks.

A magnetic recording layer is arbitrarily formed on the polycrystalline Si substrate with the silicide film or silicon alloy film, obtained in this way. A perpendicular magnetic recording medium having a stacked structure as shown in FIG. 3(B) and a next-generation heat-assisted magnetic recording medium can be obtained.

### EXAMPLES

The present invention will be more specifically described below by way of Examples, but the present invention is not intended to be limited to these Examples.

A polycrystalline Si wafer (156 mm square, and 0.6 mm thickness) having a purity of “5 nines” was prepared (S1). Four substrates per wafer was obtained by coring Si substrates, each having outside diameter 65 mm and inside diameter 20 mm, from this polycrystalline Si wafer with a laser processing machine (YAG laser, wavelength 1064 nm) (S2). These substrates were subjected to inner and outer coring (S3), adjusting thickness processing (S4), and circumferential surface polishing (S5). Then, a major surface of the polycrystalline Si substrate was subjected to a rough polishing (S6). The rough polishing was performed, using a double-side polishing machine, with slurry of colloidal silica (an average grain diameter 40 nm) of pH 8.5, at a polishing pressure of 10 kg/cm², for 10 minutes to 30 minutes, and at the maximum 1500 nm. A step height between grains on the major surface of the Si substrate after the rough polishing was inspected by using an optical inspection machine (Zygo). The result showed the order of about 5 nm.

Various metal films shown in Table 1 were deposited on the substrate that had been subjected to the rough polishing, by a magnetron sputtering apparatus and using metal targets, such that each metal film has the thickness of 1000 nm to 6000 run (S7). Before the deposition of the metal films, reverse sputtering of the substrate was performed to eliminate a natural oxide film on the substrate surface, and thereafter the metal films were deposited. The substrates were not heated when deposited by sputtering. The Si substrates with the metal films were maintained in an Ar gas atmosphere of 700 Torr at the temperatures shown in Table 1 for 30 minutes to silicidate or alloy the metal films (S8).

The film thickness of the silicide and the presence or absence of the silicidation was measured using fluorescent X-rays and thin film X-ray diffraction. In-plane film thickness distribution was 1% or less, and film thickness uniformity was good. Silicidation occurred in any film.

Subsequently, CMP polishing (S9) was performed at a polishing pressure 5 kg/cm² using fine particle colloidal silica for finishing (a pH value of 10, a grain diameter of 30 nm) to polish the silicide film to a depth of 700 nm to 1500 nm from the surface of the silicide film to obtain a smooth polished surface having less micro defect.

These polycrystalline Si substrates with the film ware subjected to scrub cleaning to eliminate residual colloidal silica, and after that subjected to precision cleaning (RCA cleaning: S10), and then evaluated for surface characteristics of the polycrystalline Si substrate by an optical inspection (S11). The substrate, specifically, was evaluated for the undulation of its polished surface (microwaviness was measured by an optical measuring instrument manufactured by Zygo Inc.) and the smoothness thereof (roughness: which was measured by an AFM apparatus manufactured by Digital Instrument Inc.).

Table 1 shows evaluation results of samples of Examples 1 to 9 obtained in this way (Ra: roughness, μ-Wa: microwaviness). Table 1 also shows an evaluation result of samples without coating, which were likewise subjected to processing in other processes, as a comparative example, at a time.

TABLE 1

| | Metal film and its processing condition | | | | | |
|---|---|---|---|---|---|---|
| | | Heat | | | | |
| | | treatment | Coating | Amounts of | | |
| | Metal | temperature | thickness | polishing | Ra | μ-Wa |
| | film | ° C. | (nm) | (nm) | (nm) | (nm) |
| Ex. 1 | Ni | 500 | 3500 | 1000 | 0.1 | 0.22 |
| Ex. 2 | Co | 500 | 2500 | 1000 | 0.11 | 0.21 |
| Ex. 3 | Cu | 450 | 2500 | 1500 | 0.08 | 0.18 |
| Ex. 4 | Ti | 550 | 2000 | 1000 | 0.12 | 0.24 |
| Ex. 5 | Zr | 600 | 2000 | 1000 | 0.12 | 0.24 |
| Ex. 6 | Mo | 600 | 1500 | 700 | 0.14 | 0.26 |
| Ex. 7 | Ta | 600 | 1200 | 700 | 0.14 | 0.28 |
| Ex. 8 | V | 600 | 800 | 700 | 0.15 | 0.3 |
| Ex. 9 | Al | 500 | 1500 | 1000 | 0.08 | 0.2 |
| Comp. | no | — | — | 1000 | 0.12 | 4.5 |
| Ex. | coating | | | | | |

As can be seen from the Table 1, the surface of the polycrystalline Si substrate with a film, which was obtained in a manner of the present invention, was flat, smooth, and good, all over the surface. No step reflecting a crystal grain distribution was observed, as observed on the surface of a polycrystal Si of a comparative example.

Each Example shows that roughness value obtained by AFM and a micro-waviness value obtained by Zygo measurement were compatible and low values. On the other hand, since the comparative example had a step height between crystal grains of the polycrystalline Si substrate, the comparative example had a very high micro-waviness value due to the presence of the steps, despite low roughness in grains.

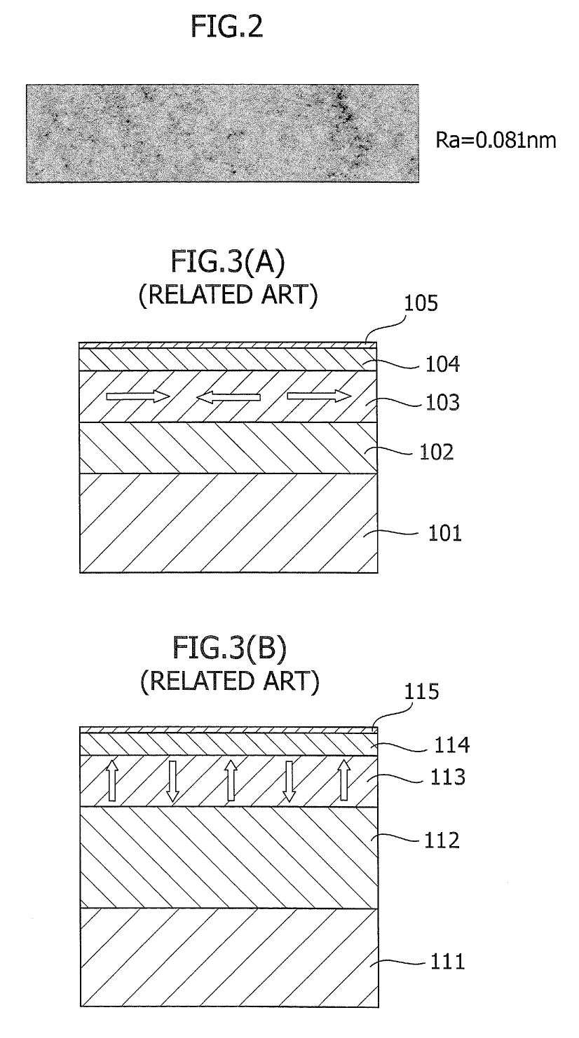

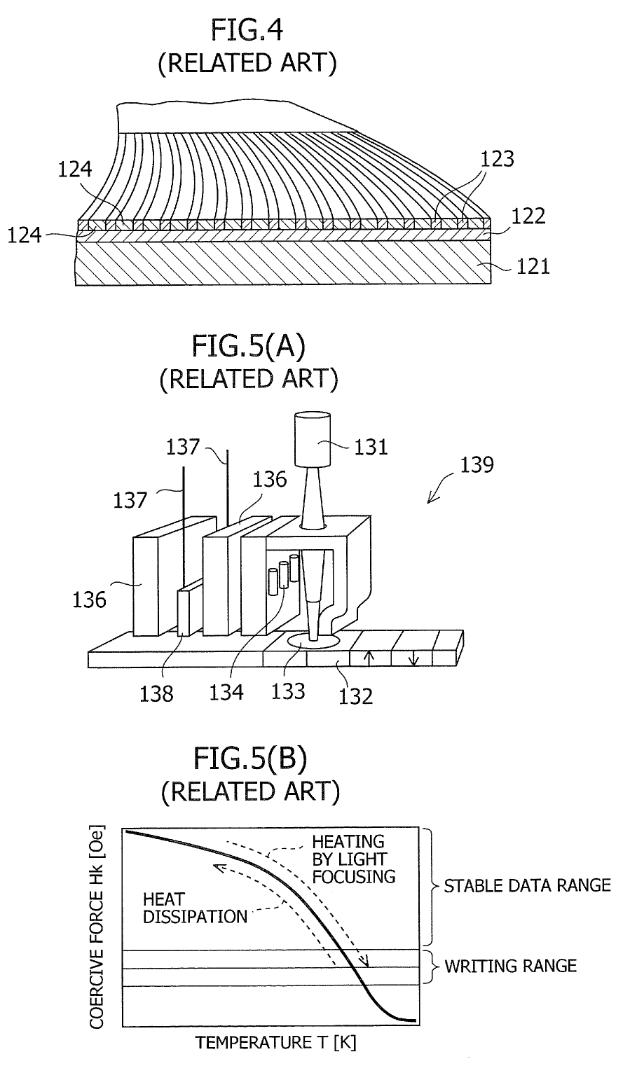

FIG. 2 shows the result of an AFM measurement when a Cu silicide film was deposited on the polycrystalline Si substrate of Example 3 and was subjected to polishing. The result shows that roughness had a value of 0.1 nm or less and thus the film was very smooth.

The thermal conductivities of the polished samples of Example 1, Example 3, and Example 9 were measured. Each sample has a thermal conductivity of 138 142, and 140 W/m·K, respectively, which were not much changed from the comparative example of only the polycrystalline Si substrate (145 W/m·K). The deposition of the silicide film on the surface had an insignificant influence on its thermal conductivity.

The present invention can provide a Si substrate for a magnetic recording medium having excellent surface flatness without making a process complex and a deposition process of a film complex, as well as a thermal conductivity that is not much changed from a bulk Si substrate of a single crystal and a polycrystal.

Having thus described certain embodiments of the present invention, it is to be understood that the invention defined by the appended claims is not to be limited by particular details set forth in the above description as many apparent variations thereof are possible without departing from the spirit or scope thereof as hereinafter claimed. The following claims are provided to ensure that the present application meets all statutory requirements as a priority application in all jurisdictions and shall not be construed as setting forth the full scope of the present invention.

1. A surface-coated silicon substrate for magnetic recording, comprising:
a polycrystalline silicon substrate; and
a metal silicide film or metal-silicon alloy film, being deposited on the polycrystalline silicon substrate and having an average thickness of 50 nm to 3 μm and a smooth surface.

2. The surface-coated silicon substrate for magnetic recording of claim 1, wherein said surface of the metal silicide film or metal-silicon alloy film has an average roughness Ra of 0.5 nm or less.

3. The surface-coated silicon substrate for magnetic recording of claim 1, wherein said metal silicide film or metal-silicon alloy film comprises one or more metals selected from the group consisting of Al, Cu, Ni, Co, Cr, Mo, W, Ti, V, Zr, Nb, and Ta.

4. The surface-coated silicon substrate for magnetic recording of claim 2, wherein said metal silicide film or metal-silicon alloy film comprises one or more metals selected from the group consisting of Al, Cu, Ni, Co, Cr, Mo, W, Ti, V, Zr, Nb, and Ta.

5. A method for manufacturing a surface-coated silicon substrate for magnetic recording, comprising the steps of:
subjecting a major surface of a polycrystalline silicon substrate to precision grinding or rough polishing;
depositing a metal film on a surface of the silicon substrate;
subjecting the metal film to a heat treatment so as to form a silicide or a silicon-alloy; and
polishing a surface with the metal silicide film or metal-silicon alloy film deposited so as to have a smooth surface.
